(19) United States
(12) Patent Application Publication
(10) Pub. No.: US 2004/0157626 A1
(43) Pub. Date: Aug. 12, 2004

(54) Paging methods and apparatus

(76) Inventors: Vincent Park, Budd Lake, NJ (US); M. Scott Corson, Chatham, NJ (US)

Correspondence Address: STRAUB & POKOTYLO, 620 TINTON AVENUE, BLDG. B, 2ND FLOOR, TINTON FALLS, NJ, 07724, US

(21) Appl. No.: 10/774,561

(22) Filed: Feb. 9, 2004

Related U.S. Application Data
(63) Continuation-in-part of application No. 10/640,961, filed on Aug. 13, 2003.
(60) Provisional application No. 60/446,327, filed on Feb. 10, 2003.

(51) Int. Cl. H04Q 7/20

(52) U.S. Cl. 455/458

(57) ABSTRACT

Improved paging methods and apparatus are described. Paging requirements for a page are determined from paging information. Paging requirements may include, e.g., transmission delay constraints, paging resource requirements, whether or not a page is to be acknowledged, quality of service information, etc. A page is generated and transmitted by the node determining the paging requirements. In other embodiments, paging requirement information is communicated in a message to a node which is responsible for paging transmission resource allocation and/or actual transmission of a page. The methods and apparatus of the present invention allow pages to be treated on a differential basis according to a page's particular requirements. Different quality of service levels can be maintained for pages with pages having a higher QoS being given resource allocation priority and/or scheduling priority over pages corresponding to lower levels of page QoS.

### RELATED APPLICATIONS

The present application claims the benefit of U.S. Provisional Patent Application S. No. 60/446,327, filed Feb. 10, 2003 titled “METHODS AND APPARATUS FOR LOCATION TRACKING AND PAGING OF MOBILE DEVICES IN WIRELESS COMMUNICATION NETWORKS” and is a continuation-in-part of U.S. patent application Ser. No. 10/640,961, filed Aug. 13, 2003, both of which are hereby expressly incorporated by reference.

### FIELD OF THE INVENTION

This invention relates to communications system and, more particularly, to methods and apparatus for paging in a wireless, e.g., cellular, communication network.

### BACKGROUND

In a typical cellular communication network, a set of geographically dispersed base stations provide wireless access to a communications infrastructure. Users with wireless communication devices, or terminals, are able to establish a direct communication link with a suitable base station and then exchange information with other users and/or end systems throughout the communication network. In general, such systems could support a variety of different applications (e.g., telephony, text messaging, streaming audio/video, web browsing, file transfer, etc.); however, traditional systems have been primarily designed for telephony. The information exchanged over the access link includes user data as well as control signaling to support the access link itself, coordinate transmissions, enable mobility, and provide many other such features.

Typically, users of a cellular communication system are not continuously engaged in active information exchange (e.g., there may be significant periods during which the end user is not participating in a communication session). A location tracking and paging system allows the wireless terminal, during periods of inactivity, to transition into a dormant mode to reduce power consumption and maximize operational lifetime, while still maintaining inbound reachability. While operating in a dormant mode, a wireless terminal may still periodically monitor a special paging channel to enable the establishment of incoming communication sessions. Thus, page signaling is typically used to alert a dormant wireless terminal of an incoming communication session. In general, page signaling may be directed to a specific location area (or paging area) comprising a subset of one or more base stations in geographic proximity to where the wireless terminal transitioned into the dormant mode or last reported its location.

The paging mechanisms of traditional, circuit-switched, cellular networks are designed primarily for voice telephony. However, circuit-switched, cellular network technology is presently being extended to support data applications as well. Additionally, there are emerging packet-switched cellular network technologies, which are better suited for supporting a wide range of applications, including interactive data applications like instant messaging and online gaming. As cellular network technology evolves to support a wider range of diverse applications with differing requirements, new paging mechanisms that enable differentiation in paging services would be desirable. Accordingly, there is a need for methods which can provide functionality such as treating different pages as having different quality of service levels and/or supporting different paging requirements for ages of different types.

In view of the above discussion, it is apparent that there is a need for improved methods and apparatus for paging.

### BRIEF DESCRIPTION OF THE FIGURES

FIG. 1 illustrates a network diagram of an exemplary communications system implemented in accordance with and using methods of the present invention.

FIG. 2 illustrates an exemplary access node implemented in accordance with the present invention.

FIG. 3 illustrates an exemplary paging node implemented in accordance with the present invention.

FIG. 4 illustrates signaling performed in accordance with an exemplary embodiment of the present invention when paging information is received by an access node and a page signal is sent by the same access node.

FIG. 5 illustrates signaling performed in accordance with an exemplary embodiment of the present invention when paging information is received by a first access node, a paging request message is sent from the first access node to a second access node, and a page signal is sent by the second access node.

FIG. 6 illustrates signaling performed in accordance with an exemplary embodiment of the present invention when paging information is received by a paging node, a paging request message is sent from the paging node to an access node, and a page signal is sent by the access node.

FIG. 7 illustrates signaling performed in accordance with an exemplary embodiment of the present invention when paging information is received by a first paging node, a paging request message is sent from the first paging node to a second paging node, and a page signal is sent from the second paging node to a plurality of access nodes and each access node sends a page signal.

FIG. 8 illustrates signaling performed in accordance with an exemplary embodiment of the present invention when paging information is received by a paging node, a page signal is sent from the same paging node to an access node and a page signal is sent by the access node.

FIG. 9 illustrates a page request message of the present invention which includes page requirement information.

FIG. 10, which comprises the combination of FIGS. 10A and 10B, illustrates steps implemented in accordance with various paging methods of the present invention.

### SUMMARY OF THE INVENTION

The present invention is directed to improved paging methods and apparatus that allow for differential treatment of pages. This capability can be used to provide different pages with differing levels of quality of service. For example, pages for voice calls may be given higher priority than pages for text messages. Alternatively, customers paying a premium for service may be given resource allocation priority for their pages over customers who do not subscribe to the premium service.

In accordance with the present invention, paging information is processed to determine the requirements for a page which is to be sent. The paging information may be a packet including information to be incorporated into a page. Alternatively the paging information may be a signal, e.g., a control signal, used to trigger a page.

Paging requirements for a page are determined from paging request information. Paging requirements may include, e.g., transmission delay constraints, paging resource requirements, whether or not a page is to be acknowledged, quality of service information, etc. The geographic region into which a page is to be initially transmitted is another example of a paging requirement. A geographic region into which a page is to be retransmitted, e.g., a different region from which the page is to be originally transmitted into, may also be determined as a requirement.

The paging requirement information may be used in a variety of ways depending on how the paging system is implemented. In one embodiment, a network node at the edge of the communications network of the invention, e.g., an access node, is responsible for determining the paging requirements, allocating resources for a page as a function of the determined paging requirements and the transmission of the page in accordance with the determined requirements and allocated paging resources.

In other embodiments, the paging requirement determination function is performed by a different node than the resource allocation and page transmission functions. In such an embodiment, the node determining the paging requirements from the received paging information generates a novel page request message in accordance with the invention and communicates the page request message to the node or element responsible for performing paging resource allocation. The novel page request message of the invention includes, the determined page requirements and, in many cases, information to be transmitted in a page having the indicated requirements. The information to be transmitted is normally a portion of the page information from which the page requirements were determined. The page request message of the present invention is stored in memory, e.g., buffered, in the nodes which generate, transmit, receive and/or process the novel message of the present invention.

After allocation of page transmission resources, e.g., as a function of the determined page requirement information, pages are scheduled and transmitted, e.g., in accordance with each page's individual requirements. The techniques of the present invention allow different pages to be treated differently thereby providing a mechanism where different levels of quality of service QoS for page transmission can be supported. This offers significant advantages over systems where all pages are treated the same in terms of transmission resource allocation and/or other page related requirements such as the region into which a page is transmitted, requirements for page acknowledgments, etc. In various embodiments the page requirements specify an action to be taken by a mobile node in response to receiving a page. While a page acknowledgment is one example, changing into a particular mode of operation, e.g., from one lower power state of operation another low power state of operation instead of full-on state may be specified as a page requirement. In such a case the page requirement is often incorporated into the actual page message which is generated as a function of the determined page requirement information.

The methods and apparatus of the present invention allow pages to be treated on a differential basis according to a page's particular requirements. Different quality of service levels can be maintained for pages with pages assigned a higher QoS level being given resource allocation priority and/or scheduling priority over pages corresponding to lower levels of paging QoS.

Thus, the present invention provides novel paging methods and apparatus as well as new, efficient messages for communicating page requirements alone or in conjunction with information to be transmitted in a page. Numerous additional features, benefits and applications of the methods and apparatus of the present invention are discussed in the detailed description which follows.

### DETAILED DESCRIPTION OF THE FIGURES AND THE INVENTION

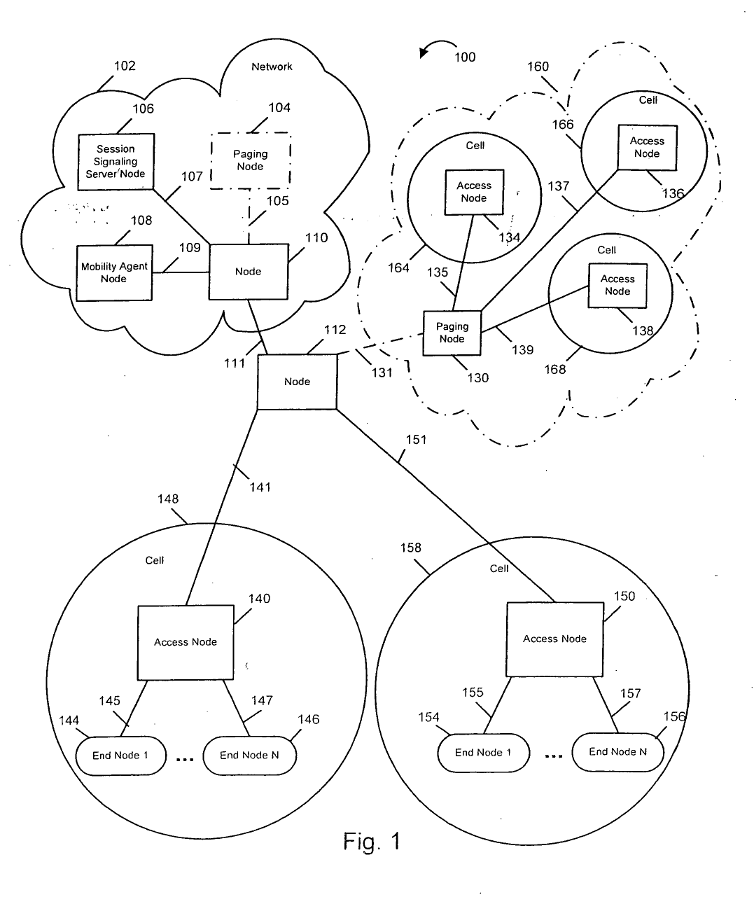

FIG. 1 illustrates an exemplary communication system 100, e.g., a cellular communication network, which comprises a plurality of nodes interconnected by communications links. Nodes in the exemplary communication system 100 may exchange information using signals, e.g., messages, based on communication protocols, e.g., the Internet Protocol (IP). The communications links of the exemplary system 100 may be implemented, for example, using wires, fiber optic cables, and/or wireless communications techniques. The exemplary communication system 100 includes a plurality of end nodes 144, 146, 154, 156, which access the communication system via a plurality of access nodes 140, 150. The end nodes 144, 146, 154, 156 may be, e.g., wireless communication devices or terminals, and the access nodes 140, 150 may be, e.g., wireless access routers or base stations. The exemplary communication system 100 also includes a number of other nodes as may be needed to provide interconnectivity or to provide specific services or functions. Specifically, the exemplary communication system 100 includes a session signaling server node 106, e.g., Session Initiation Protocol (SIP) proxy server, as may be needed to support establishment and maintenance of communication sessions between end nodes and a mobility agent node 108, e.g., Mobile IP home agent node, as may be needed to support mobility of end nodes between access nodes.

The FIG. 1 exemplary communication system 100 includes a network 102 that includes the session signaling server node 106, and the mobility agent node 108, each of which is connected to an intermediate network node 110 by a corresponding network link 107, 109, respectively. The exemplary system 100 also depicts a paging node 104 that is included in some embodiments but not in others depending on the paging system design and architecture, where the paging node 104, if present, is connected to the intermediate network node 110 by a corresponding network link 105. The paging node 104 and associated network link 105 are depicted with doted-dashed lines to emphasize inclusion in some embodiments but not in others. The intermediate network node 110 in the network 102 also provides interconnectivity to network nodes that are external from the perspective of the network 102 via network link 111. Network link 111 is connected to another intermediate network node 112, which provides further connectivity to a plurality of access nodes 140, 150 via network links 141, 151, respectively.

The exemplary system 100 includes a set of access nodes 134, 136, 138 and an associated paging node 130 that are part of a network 160 that primarily uses different communication technology, e.g., circuit-switched, than that of other nodes, e.g., packet switched, in the unified communication system 100. Each access node 134, 136, 138 of the dissimilar technology network 160 is connected to the paging node 130 by a corresponding network link 135, 137, 139, respectively, while the paging node 130 of the dissimilar technology network 160 is interconnected via a network link 131 to an intermediate node 112 of the unified communication system 100. To emphasize that some embodiments of the present invention operate in a communication system 100 that integrates networks of different communication technologies, while other embodiments do not, the dissimilar technology network 106 and the interconnecting network link 131 are depicted with doted-dashed lines.

Several access nodes 140, 150 in the exemplary communication system 100 are depicted as providing connectivity to a plurality of N end nodes (144, 146), (154, 156), respectively, via corresponding access links (145, 147), (155, 157), respectively. Although not explicitly depicted, the other access nodes 134, 136, 138 in the exemplary communication system 100 include similar functionality for providing connectivity to end nodes. In the exemplary communication system 100, each access node 134, 136, 138, 140, 150 is depicted as using wireless technology, e.g., wireless access links, to provide access. A radio coverage area, e.g., communications cell, 164, 166, 168, 148, 158 of each access node 134, 136, 138, 140, 150, respectively, is illustrated as a circle surrounding the corresponding access node.

The exemplary communication system 100 is subsequently used as a basis for the description of various embodiments of the invention. Alternative embodiments of the invention include various network topologies, where the number and type of network nodes, the number and type of links, and the interconnectivity between nodes may differ from that of the exemplary communication system 100 depicted in FIG. 1.

In accordance with the present invention, support for differentiated paging in the exemplary system 100 is enabled by the following functional entities which may be implemented, e.g., in one or more modules.

1. Paging Requirements Determination (PRD): The PRD functional entity analyzes received paging information, e.g., a received data message or control signal that indicates a particular dormant end node should be paged, and determines the requirements of a corresponding page, e.g., paging operation and/or signaling.

2. Paging Resource Control (PRC): The PRC functional entity controls one or more paging resources, performs paging operations (e.g., allocates paging resources), and/or sends page signaling in accordance with the requirements of a page, as determined by a PRD functional entity.

In various embodiments of the present invention these functional entities may be implemented in separate modules or combined in a single module. Furthermore, in various embodiments, e.g., depending on the paging system designs, these functional entities may be located in different network nodes or co-located in some network nodes. In embodiments where both functional entities are co-located in a given network node, the individual functional entities may be, e.g., selectively enabled/disabled or remain unused in some modes of operation.

In centralized paging system design, both PRD and PRC functions may be centrally located in the core of the network infrastructure. In a partially distributed paging system design, the PRD function may be centrally located in the core of the network, while the PRC function may be located at or near the edge of the network infrastructure, e.g., in radio access network nodes or access nodes. In an even more distributed paging system design both PRD and PRC functions may be located at the edge of the network infrastructure, e.g., in the access nodes. In various embodiments of the present invention, a single PRC functional entity may support a plurality of access nodes/cells/sectors, defined to be within the local scope of the PRC functional entity.

In accordance with the present invention, support for location tracking and paging of end nodes in the exemplary system 100 is further enabled by the following functional entities which may be implemented, e.g., in one or more modules.

1. Monitoring Agent (MA): The MA receives and processes incoming paging information, e.g., messages, for a dormant end node and determines if paging should be initiated for the end node.

2. Tracking Agent (TA): The TA receives location update signals, e.g., messages, to track a dormant end node's location, e.g., current location/paging area, access node, cell and/or sector. The frequency of location updates and accuracy of location tracking information maintained by the TA is implementation dependent.

3. Anchor Paging Agent (APA): The APA coordinates page request signaling, e.g., sends page request messages, for a dormant end node. Typically the APA initiates page request signaling in response to a trigger signal from the MA, and directs page signals to other network nodes, e.g., access nodes, based on tracking information maintained by the TA.

4. Local Paging Agent (LPA): The LPA coordinates signaling between other functional entities, e.g., end node, TA and/or APA. Typically, an LPA coordinates signaling between entities within an associated scope (e.g., a location area comprising one or more access nodes and the set end nodes within coverage of those access nodes) and other functional entities (e.g., TA and/or APA) that may be located outside of that scope.

In various embodiments of the present invention some of these functional entities may be omitted or combined. The location or placement of these functional entities within in the network and/or within specific network nodes may also be varied in different embodiments.

In general, the MA, TA, and APA are closely related and collectively maintain state information on dormant end nodes to enable location tracking and paging. Thus, these three functions may often be collocated within the same node or in nodes that are topologically in close proximity to one another. The present invention supports both centralized paging system designs and more distributed design in which these functions are located at or neat the edge of the network infrastructure, e.g., in the access nodes. The LPA essentially serves to coordinate signaling between other functional entities, e.g., the end node in its present location (e.g., its current location/paging area, access node, cell, and/or sector), and the MA/TA/APA that is supporting the dormant end node (which may be located elsewhere in the network). Thus, the LPA function is typically more distributed and located at or near the edge of the network infrastructure, e.g., in the access nodes. In various embodiments of the present invention, a single LPA may support a plurality of access nodes/cells/sectors, defined to be within the local scope of the LPA.

The following describes various exemplary embodiments of the present invention that support various paging system designs.

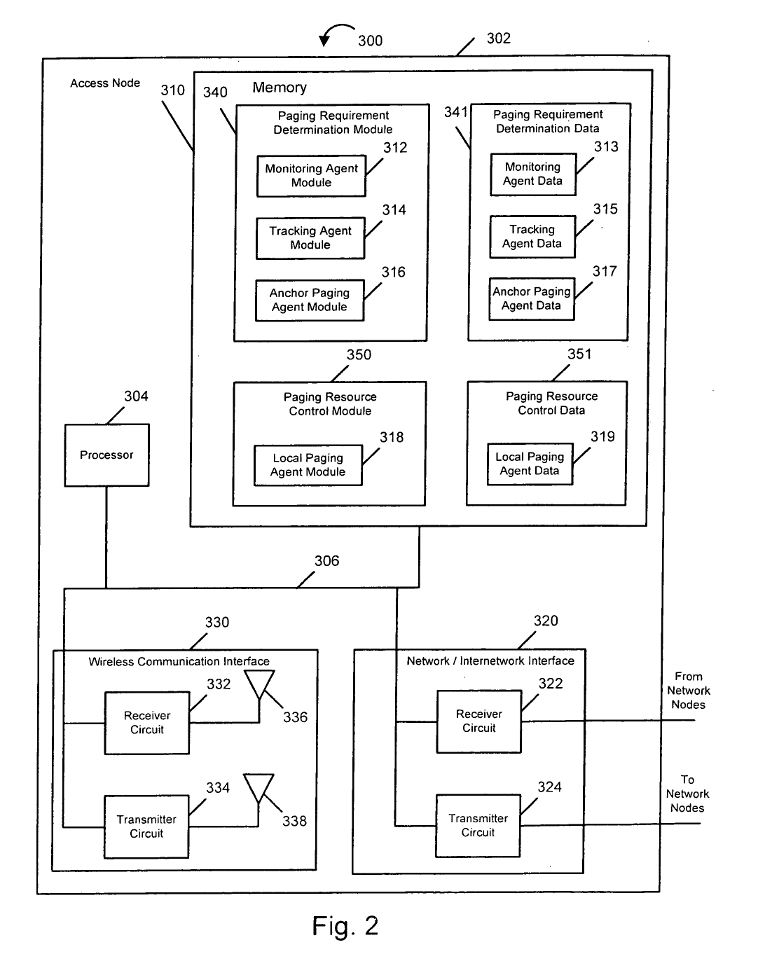

FIG. 2 provides a detailed illustration of an exemplary access node 300 implemented in accordance with the present invention. The exemplary access node 300, depicted in FIG. 2, is a detailed representation of an apparatus that may be used as an access node, e.g., 140, 150, depicted in FIG. 1. In the FIG. 2 embodiment, the access node 300 includes a processor 304, a network/internetwork interface 320, a wireless communication interface 330 and memory 310, coupled together by bus 306. Accordingly, via bus 306 the various components of the access node 300 can exchange information, signals and data. The components 304, 306, 310, 320, 330 of the access node 300 are located inside a housing 302.

The network/internetwork interface 320 provides a mechanism by which the internal components of the access node 300 can send and receive signals to/from external devices and network nodes. The network/internetwork interface 320 includes, a receiver circuit 322 and a transmitter circuit 324 used for coupling the access node 300 to other network nodes, e.g., via copper wires or fiber optic lines. The wireless communication interface 330 also provides a mechanism by which the internal components of the access node 300 can send and receive signals to/from external devices and network nodes, e.g., end nodes. The wireless communication interface 330 includes, e.g., a receiver circuit 332 with a corresponding receiving antenna 336 and a transmitter circuit 334 with a corresponding transmitting antenna 338 used for coupling the access node 300 to other network nodes, e.g., via wireless communication channels.

The processor 304 under control of various modules, e.g., routines, included in memory 310 controls operation of the access node 300 to perform various signaling and processing, as discussed below. The modules included in memory 310 are executed on startup or as called by other modules. Modules may exchange data, information, and signals when executed. Modules may also share data and information when executed. In the FIG. 2 embodiment, the memory 310 of the access node 300 of the present invention includes a PRD module 340 with corresponding PRD data 341 and a PRC module 350 with corresponding PRC data 351. The PRD module 340 is depicted as including an MA module 312, a TA module 314, an APA module 316, while the PRC module 350 is depicted as including an LPA module 318. Corresponding to each of these agent modules, memory 310 also includes MA data 313, TA data 315, APA data 317, and LPA data 319.

The PRD module 340 controls the operation of the access node 300 to support PRD functionality. The PRD module 340 analyzes received paging information, e.g., a received data message or control signal that indicates a particular dormant end node should be paged, and determines the requirements of a corresponding page, e.g., paging operation and/or signaling. The requirements determination step is a function of at least one of a quality of service indicator, a type indicator, a source indicator and a destination indicator included in the paging information. In some embodiments, one or more of these indicators is explicitly included in the received paging information, e.g., a value of a field in either the header or payload of a received message. Additionally, one or more of these indicators may be implicitly inferred from the received paging information. The PRD data 341 located in the access node 300 includes, e.g., match criteria information, corresponding paging requirements, parameters, and operational state related to providing the PRD functionality. In some embodiments, one or more indicators included in the received paging information are compared with match criteria included in the PRD data 341 to determine the corresponding paging requirements. The determined requirement may subsequently be used by a PRC functional entity to control paging.

In some embodiments, the PRD module 340 communicates the determined requirement, e.g., sends a paging request signal or paging request message indicating the determined requirement, to a PRC functional entity, e.g., a PRC module co-located in the same access node 300 or located in a different network node. In some embodiments that communicate the determined requirements in, e.g., a paging request message, the determined requirements are conveyed as values in one or more fields in, e.g., the message header or payload. In some embodiments conveyed information includes a portion of the received paging information intended for delivery to the dormant end node. Specific requirements may be conveyed in individual fields or multiple requirements may be collectively encoded into a common field. Some embodiments of the invention may use alternative means of conveying the determined requirements information, e.g., via shared memory when PRD module and PRC module are co-located in the same access node.

The PRC module 350 controls the operation of the access node 300 to support PRC functionality. The PRC module 350 controls one or more paging resources, performs paging operations (e.g., allocates paging resources), and/or sends page signaling in accordance with the requirements of a page, as determined by a PRD functional entity. The PRC module 350 receives an indication of paging requirements as determined by a PRD functional entity, e.g., a PRD module co-located in the same access node 300 or located in a different network node. The PRC module 350 interprets the determined requirements conveyed from the PRD functional entity and uses the determined requirements to control paging operations and or signaling. The PRC data 351 located in the access node 300 includes, e.g., paging request message parsing information, parameters, and operational state related to providing the PRC functionality. In some embodiments, the PRC module 350 allocates one or more paging resources, e.g., a page transmission resource, based on the determined requirements. In various embodiments the PRC module 350 sends page signaling, e.g., transmits a page, in response to receiving a page request signal, e.g., message from a PRD functional entity. The PRC module 350 may direct page signaling to one or more other network nodes in accordance with the paging system design.

The FIG. 2 exemplary access node 300 also includes MA, TA, APA and LPA functionality. An MA module 312, a TA module 314 and an APA module 316 are included in the PRD module 340, while an LPA module 318 is included in the PRC module 350. Correspondingly MA data 313, TA data 315, and APA data 317 are included in the PRD data 341, while LPA data 319 is included in the PRC data 351.

The MA module 312 controls the operation of the access node 300 to support MA functionality for one or more dormant end nodes. The MA module 312 intercepts, and optionally stores, incoming signals, e.g., messages, destined for associated dormant end nodes and determines if a paging procedure should be initiated for the corresponding end node. In some embodiments, the MA additionally, or alternatively, receives control signals indicating that a particular dormant end node should be paged. The MA module 312 controls the interception and processing of received signals from other network nodes destined for associated dormant end nodes, the classification and filtering of said intercepted incoming signals to determine whether a page procedure for the corresponding end node should be initiated, and the sending of subsequent signals, as required to trigger the APA module 316 to commence a page procedure. The MA data 313 includes, e.g., end node identifiers, parameters, filtering information, and/or other information relating to providing MA functionality as described herein. The MA module 312 may access and/or modify the MA data 313.

The Tracking Agent module 314 controls the operation of the access node 300 to support TA functionality for one or more dormant end nodes. The TA module 314 maintains location information, e.g., location/paging area, access node, cell and/or sector, for associated dormant end nodes and provides said information to other entities. While an end node is dormant, it may send location update request signals to its corresponding TA module. The frequency of location update request signals and accuracy of location information maintained by the TA is implementation dependent. The TA module 314 controls the processing of received location update request signals and updating of the corresponding end node location information, the processing of received signals from other entities, e.g., other network nodes or other modules such as APA modules 316, requesting location information, e.g., current location/paging area, access node, cell and/or sector, associated with a particular dormant end node, and the sending of subsequent signals in response to requests from other entities, as required to provide acknowledgment or the requested information. The TA data 315 includes, e.g., end node location information and other information relating to providing TA functionality. The TA module 314 may access and/or modify the TA data 315.

The APA module 316 controls the operation of the access node 300 to support APA functionality for dormant end nodes. In some embodiments, the APA module 316 provides the logic and control associated with paging a dormant end node. The APA module controls the processing of received trigger signals from other entities, e.g., other network nodes or other modules such as the MA module 312, indicating that a page procedure should be initiated for a particular dormant end node, the exchange of signaling with the TA module 314 as needed to determine location of the dormant end node, the sending of subsequent page request signals to other entities, e.g., other network nodes or other modules such as the LPA module 318, and the processing of any corresponding response signals. The APA data 317 includes, information regarding the page procedure itself for each dormant end node or class of end nodes, e.g. frequency of page request signals sent to other nodes, time-out values for the period to wait for responses, operations to undertake in case time-outs are reached, etc. The APA module 316 may access and/or modify the APA data 317.

The LPA module 318 controls the operation of the access node 300 to support LPA functionality for dormant end nodes. The LPA module 318 supports coordination of page signaling and location tracking signaling within its local scope, e.g., a set of associated access node(s)/cell(s)/sector(s). The LPA module 318 controls the processing of received page request signals for a particular dormant end node, e.g., from an APA module 316 located in the same access node or some other network node, the sending page signals for a particular dormant end node, e.g., over the wireless communication interface 330, the receiving of any page response signals, and sending or relaying of page response signals to the entity, e.g., an APA module, that initiated the page procedure. In some embodiments, the LPA module 318 also controls the processing of received location update signals associated with dormant end nodes within its local scope, the sending or relaying of location update signals to the entity, e.g., a TA module, providing TA functionality for the particular dormant end node, the receiving of location update response signals from the entity providing TA functionality, and the sending or relaying of location update response signals. The LPA data 319 includes, e.g., end-node related data regarding the operation of a page procedure, such as frequency of page signals, channels to be used, time-out periods, etc. The LPA module 318 may access and/or modify the LPA data 319.

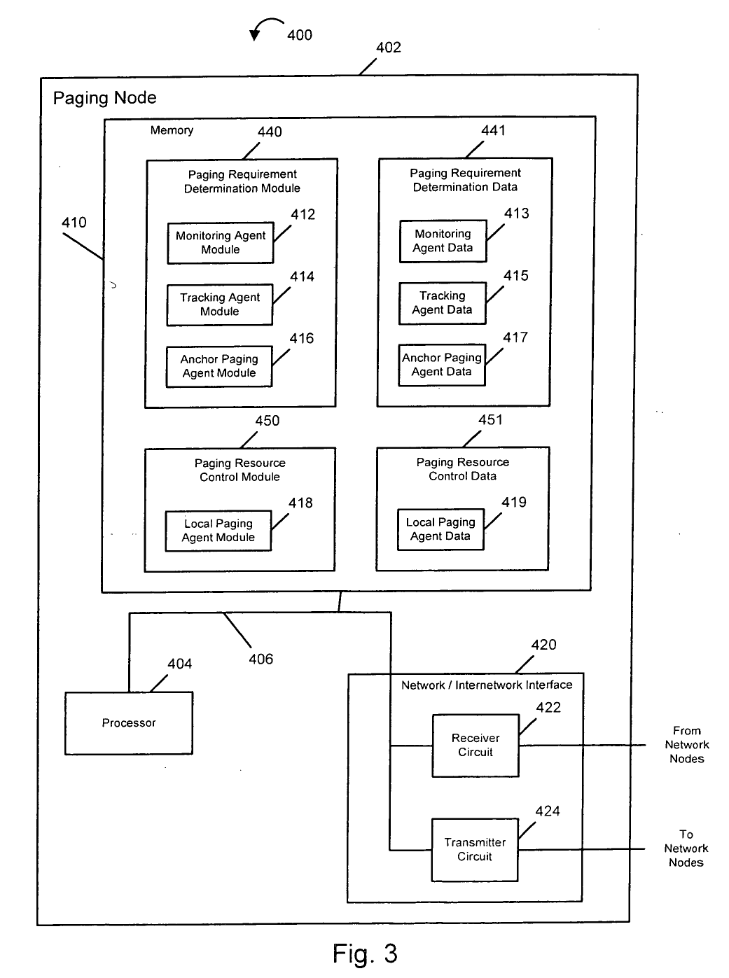

FIG. 3 provides a detailed illustration of an exemplary paging node 400 implemented in accordance with the present invention. The exemplary paging node 400, depicted in FIG. 3, is a detailed representation of an apparatus that may be used as a paging node, e.g., 104, 130, depicted in FIG. 1. In the FIG. 3 embodiment, the paging node 400 includes a processor 404, a network/internetwork interface 420 and memory 410, coupled together by bus 406. Accordingly, via bus 406 the various components of the paging node 400 can exchange information, signals and data. The components 404, 406, 410, 420 of the paging node 400 are located inside a housing 402.

The network/internetwork interface 420 provides a mechanism by which the internal components of the paging node 400 can send and receive signals to/from external devices and network nodes. The network/internetwork interface 420 includes a receiver circuit 422 and a transmitter circuit 424 used for coupling the paging node 400 to other network nodes, e.g., via copper wires or fiber optic lines.

The processor 404 under control of various modules, e.g., routines, included in memory 410 controls operation of the paging node 400 to perform various signaling and processing, as discussed below. The modules included in memory 410 are executed on startup or as called by other modules. Modules may exchange data, information, and signals when executed. Modules may also share data and information when executed. In the FIG. 3 embodiment, the memory 410 of the paging node 400 of the present invention includes a PRD module 440 with corresponding PRD data 441 and a PRC module 450 with corresponding PRC data 451. The PRD module 440 is depicted as including an MA module 412, a TA module 414, an APA module 416, while the PRC module 450 is depicted as including an LPA module 418. Corresponding to each of these agent modules, memory 410 also includes MA data 413, TA data 415, APA data 417, and LPA data 419.

The PRD module 440 controls the operation of the paging node 400 to support PRD functionality. The PRD module 440 analyzes received paging information, e.g., a received data message or control signal that indicates a particular dormant end node should be paged, and determines the requirements of a corresponding page, e.g., paging operation and/or signaling. The requirements determination step is a function of at least one a quality of service indicator, a type indicator, a source indicator and a destination indicator included in the paging information. In some embodiments, one or more of these indicators is explicitly included in the received paging information, e.g., a value of a field in either the header or payload of a received message. Additionally, one or more of these indicators may be implicitly inferred from the received paging information. The PRD data 441 located in the paging node 400 includes, e.g., match criteria information, corresponding paging requirements, parameters, and operational state related to providing the PRD functionality. In some embodiments, one or more indicators included in the received paging information are compared with match criteria included in the PRD data 441 to determine the corresponding paging requirements. The determined requirement may subsequently be used by a PRC functional entity to control paging.

In some embodiments, the PRD module 440 communicates the determined requirement, e.g., sends a paging request signal or paging request message indicating the determined requirement, to a PRC functional entity, e.g., a PRC module co-located in the same paging node 400 or located in a different network node. In some embodiments that communicate the determined requirements in, e.g., a paging request message, the determined requirements are conveyed as values in one or more fields in, e.g., the message header or payload. In some embodiments conveyed information includes a portion of the received paging information intended for delivery to the dormant end node. Specific requirements may be conveyed in individual fields or multiple requirements may be collectively encoded into a common field. Some embodiments of the invention may use alternative means of conveying the determined requirements information, e.g., via shared memory when PRD module and PRC module are co-located in the same paging node.

The PRC module 450 controls the operation of the paging node 400 to support PRC functionality. The PRC module 450 controls one or more paging resources, performs paging operations (e.g., allocates paging resources), and/or sends page signaling in accordance with the requirements of a page, as determined by a PRD functional entity. The PRC module 450 receives an indication of paging requirements as determined by a PRD functional entity, e.g., a PRD module co-located in the same paging node 400 or located in a different network node. The PRC module 450 interprets the determined requirements conveyed from the PRD functional entity and uses the determined requirements to control paging operations and/or signaling. The PRC data 451 located in the paging node 400 includes, e.g., paging request message parsing information, parameters, and operational state related to providing the PRC functionality. In some embodiments, the PRC module 450 allocates one or more paging resources, e.g., a page transmission resource, based on the determined requirements. In various embodiments the PRC module 450 sends page signaling, e.g., transmits a page, in response to receiving a page request signal, e.g., message from a PRD functional entity. The PRC module 450 may direct page signaling to one or more other network nodes in accordance with the paging system design.

The FIG. 3 exemplary paging node 400 also includes MA, TA, APA and LPA functionality. An MA module 412, a TA module 414 and an APA module 416 are included in the PRD module 440, while an LPA module 418 is included in the PRC module 450. Correspondingly MA data 413, TA data 415, and APA data 417 are included in the PRD data 441, while LPA data 419 is included in the PRC data 451.

The MA module 412 controls the operation of the paging node 400 to support MA functionality for one or more dormant end nodes. The MA module 412 intercepts, and optionally stores, incoming signals, e.g., messages, destined for associated dormant end nodes and determines if a paging procedure should be initiated for the corresponding end node. In some embodiments, the MA additionally, or alternatively, receives control signals indicating that a particular dormant end node should be paged. The MA module 412 controls the interception and processing of received signals from other network nodes destined for associated dormant end nodes, the classification and filtering of said intercepted incoming signals to determine whether a page procedure for the corresponding end node should be initiated, and the sending of subsequent signals, as required to trigger the APA module 416 to commence a page procedure. The MA data 413 includes, e.g., end node identifiers, parameters, filtering information, and/or other information relating to providing MA functionality as described herein. The MA module 412 may access and/or modify the MA data 413.

The Tracking Agent module 414 controls the operation of the paging node 400 to support TA functionality for one or more dormant end nodes. The TA module 414 maintains location information, e.g., location/paging area, access node, cell and/or sector, for associated dormant end nodes and provides said information to other entities. While an end node is dormant, it may send location update request signals to its corresponding TA module. The frequency of location update request signals and accuracy of location information maintained by the TA is implementation dependent. The TA module 414 controls the processing of received location update request signals and updating of the corresponding end node location information, the processing of received signals from other entities, e.g., other network nodes or other modules such as APA modules 416, requesting location information, e.g., current location/paging area, access node, cell and/or sector, associated with a particular dormant end node, and the sending of subsequent signals in response to requests from other entities, as required to provide acknowledgment or the requested information. The TA data 415 includes, e.g., end node location information and other information relating to providing TA functionality. The TA module 414 may access and/or modify the TA data 415.

The APA module 416 controls the operation of the paging node 400 to support APA functionality for dormant end nodes. In some embodiments, the APA module 416 provides the logic and control associated with paging a dormant end node. The APA module controls the processing of received trigger signals from other entities, e.g., other network nodes or other modules such as the MA module 412, indicating that a page procedure should be initiated for a particular dormant end node, the exchange of signaling with the TA module 414 as needed to determine location of the dormant end node, the sending of subsequent page request signals to other entities, e.g., other network nodes or other modules such as the LPA module 418, and the processing of any corresponding response signals. The APA data 417 includes, information regarding the page procedure itself for each dormant end node or class of end nodes, e.g. frequency of page request signals sent to other nodes, time-out values for the period to wait for responses, operations to undertake in case time-outs are reached, etc. The APA module 416 may access and/or modify the APA data 417.

The LPA module 418 controls the operation of the paging node 400 to support LPA functionality for dormant end nodes. The LPA module 418 supports coordination of page signaling and location tracking signaling within its local scope, e.g., a set of associated access node(s)/cell(s)/sector(s). The LPA module 418 controls the processing of received page request signals for a particular dormant end node, e.g., from an APA module 416 located in the same paging node or some other network node, the sending of page signals for a particular dormant end node, the receiving of any page response signals, and sending or relaying of page response signals to the entity, e.g., an APA module, that initiated the page procedure. In some embodiments, the LPA module 418 also controls the processing of received location update signals associated with dormant end nodes within its local scope, the sending or relaying of location update signals to the entity, e.g., a TA module, providing TA functionality for the particular dormant end node, the receiving of location update response signals from the entity providing TA functionality, and the sending or relaying of location update response signals. The LPA data 419 includes, e.g., end-node related data regarding the operation of a page procedure, such as frequency of page signals, channels to be used, time-out periods, etc. The LPA module 418 may access and/or modify the LPA data 419.

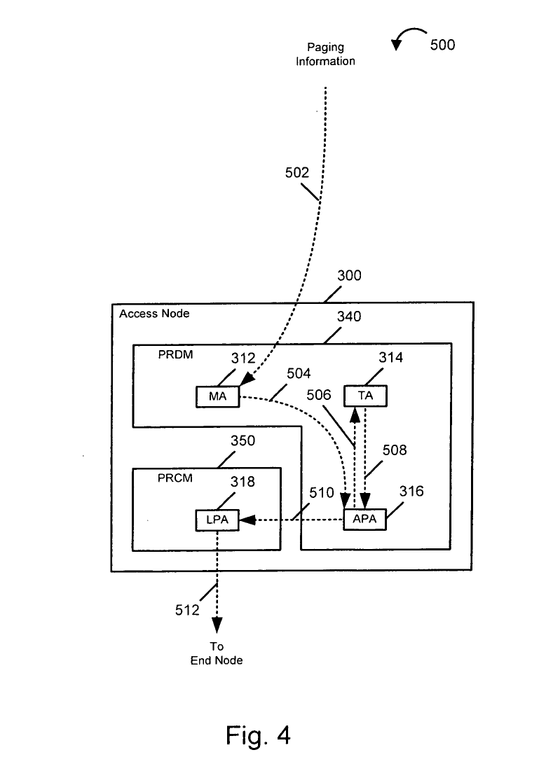

FIGS. 4, 5, 6, 7 and 8 illustrate the signaling performed in accordance with an exemplary embodiment of the invention in the context of the FIG. 1 exemplary communication system 100. As compared with FIG. 1, the illustrations in FIGS. 4-8 are more logical in nature rather than physical, so only a relevant sub-set of the nodes in the exemplary communication system 100 are depicted, thus, many of the physical nodes and links have been omitted. Where signaling, e.g., delivery of a message, is shown between two nodes, modules and/or entities, it is assumed that such signaling is conveyed as needed via intermediate nodes, links, buses, etc. that physically interconnect the source and destination of the illustrated signaling.

FIG. 4 provides a detailed illustration of exemplary signaling 500 in accordance with the present invention, when a paging operation is performed in a communication system with an distributed paging system design and when the tracking information for the dormant end node to be paged indicates the dormant end node is within the scope of an LPA co-located in the same access node that initiates the paging operation. In the FIG. 4 example, both PRD functionality and PRC functionality associated with the paging operation are performed by the same access node. In the FIG. 4 example, a single access node 300, implemented in accordance with the present invention, is depicted. The FIG. 4 access node 300 is a simplified representation of the exemplary access node 300 depicted in FIG. 2. In the context of the FIG. 1 exemplary communication system 100, the FIG. 4 access node 300 may represent, e.g., an access node 140 depicted in FIG. 1.

In the FIG. 4 illustration, the paging operation is initiated by the access node 300 upon reception of paging information 502, e.g., a data message destined for a dormant end node or a control signal indicating that a dormant end node should be paged. The MA module 312 intercepts the paging information 502 and determines that a paging operation should be initiated. The PRD module 340 further analyses the received paging information 502 to determine the requirements of the paging operation to be initiated. In some embodiments of the present invention, the MA module 312, as part of the PRD module 340, further analyses the received paging information 502 to determine the requirements of the paging operation to be initiated. The requirements determination, made by the PRD module 340, is a function of at least one of a quality of service indicator, a type indicator, a source indicator and a destination indicator included in the paging information 502. In some embodiments, the requirements determination is based in part on configuration and operational information included in the PRD data 341. In particular, the PRD data 341 may, and in some embodiments does, include match criteria information and corresponding paging requirements information that enables the PRD module 340 to determine the specific paging requirements, e.g., IP datagrams may be matched to specific requirements using traditional packet classification techniques based on header fields.

Upon determination that the received paging information 502 warrants paging a dormant end node, the MA module 312 sends a page trigger signal 504 to the APA module 316, indicating that a particular dormant end node should be paged. Upon receiving and processing the page trigger signal 504, the APA module 316 sends a location request signal 506 to the TA module 314. The TA module 314 access its corresponding TA data 315 to determine the location information associated with the dormant end node and returns the information, e.g., location/paging area, access node, cell, sector and/or corresponding LPA, to the APA module 316 in a location response signal 508. The location information associated with the dormant end node may, and in some embodiments does, indicate a plurality of location/paging areas, access nodes, cells, sectors and/or LPAs, where the dormant end node may be located. When the location information comprises multiple such entities, a variety of paging strategies, e.g., blanket, expanding ring, or sequential, may be used to search for the dormant end node.

Upon receiving the location information associated with the dormant end node, e.g., via the location response signal 508, the APA module 316 determines the set of one or more access nodes or LPA modules to which page request signaling should be sent. In the FIG. 4 example, the APA module 316 (of the PRD module 340) sends a page request signal 510 to the LPA module 318 (of the PRC module 350 located in same access node 300). The page request signal 510 contains an indication of the dormant end node to be paged, and in some embodiments, the page request signal also includes an indication of the paging requirements determined by the PRD module 340. Note that in the FIG. 4 example, since the PRD module 340 and PRC module 350 are co-located in the same access node 300, the determined paging requirements may be, and in some embodiments is, conveyed via other means, e.g., through shared memory.

The LPA module 318 receives and processes the page request signal 510. The PRC module 350 interprets the determined requirements conveyed from the PRD module 340 and uses the determined requirements to control paging operations and or subsequent page signaling. In some embodiments, the PRC module 350 allocates one or more paging resources, e.g., a page transmission resource, based on the determined requirements corresponding to the received page request signal 510. Note that in some embodiments, the PRC module 350 receives page request signals from one or more PRD modules, e.g., from one or more access nodes and/or paging nodes, and in some cases may have multiple page request pending simultaneously. In such embodiments, the PRC module 350 allocates paging resources, e.g., transmits pages, as a function of the determined requirements corresponding to the pending requests. Thus, a pending page request with a time constraint requirement, e.g., indicating paging latency should be minimized or an upper bound on paging delay, may be serviced prior to other pending requests that were received earlier. Additionally, in some embodiments, a plurality of paging requests signals are associated as a group, e.g., a group with a common quality of service indicator, and one or more paging resources is allocated to the group, e.g., a minimum fraction of paging channel capacity or paging transmission opportunities is allocated for page requests associated with the group. In the FIG. 4 example, the LPA module 318, as part of the PRC module 350, sends a page request signal 512 for the particular dormant end node via the wireless communication interface 330.

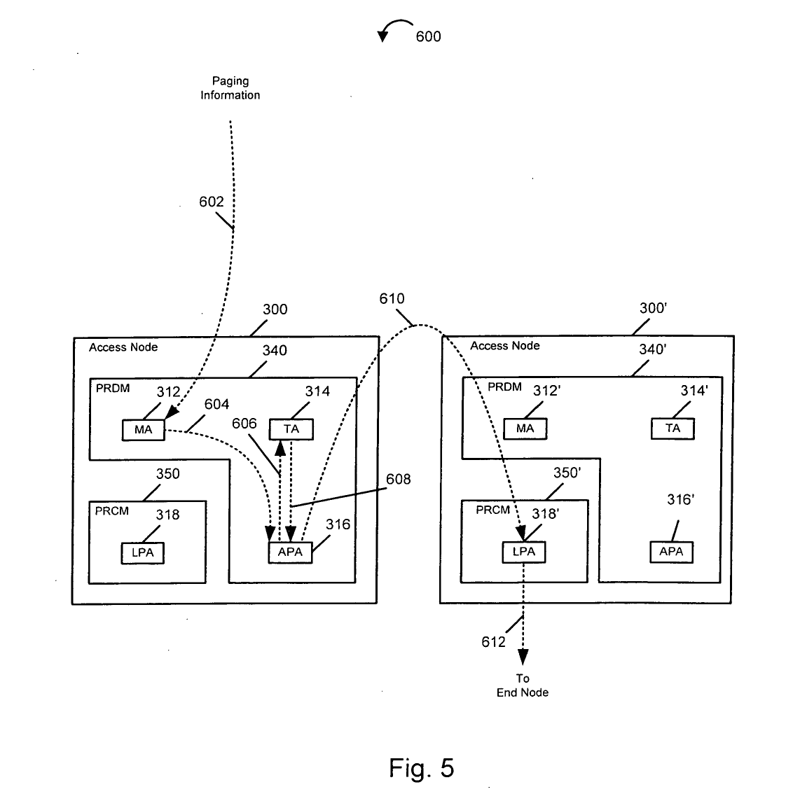

FIG. 5 provides a detailed illustration of exemplary signaling 600 in accordance with the present invention, when a paging operation is performed in a communication system with an distributed paging system design and when the tracking information for the dormant end node to be paged indicates the dormant end node is within the scope of an LPA located in an access node other than the access node that initiates the paging operation. In the FIG. 5 example, PRD functionality associated with the paging operation is performed by a first access node, while PRC functionality associated with the paging operation is performed by a second access node. In the FIG. 5 example, two access nodes 300, 300′, implemented in accordance with the present invention, are depicted. Each of the FIG. 5 access nodes 300, 300′ is a simplified representation of an access node implemented in accordance with the exemplary access node 300 depicted in FIG. 2. In the context of the FIG. 1 exemplary communication system 100, the first FIG. 5 access node 300 may represent, e.g., a first access node 140 depicted in FIG. 1, while the second FIG. 5 access node 300′ may represent, e.g., a second access node 150 depicted in FIG. 1.

In the FIG. 5 illustration, the paging operation is initiated by the first access node 300 upon reception of paging information 602, e.g., a data message destined for a dormant end node or a control signal indicating that a dormant end node should be paged. The MA module 312 intercepts the paging information 602 and determines that a paging operation should be initiated. The PRD module 340 further analyses the received paging information 602 to determine the requirements of the paging operation to be initiated. In some embodiments of the present invention, the MA module 312, as part of the PRD module 340, further analyses the received paging information 602 to determine the requirements of the paging operation to be initiated. The requirements determination, made by the PRD module 340, is a function of at least one of a quality of service indicator, a type indicator, a source indicator and a destination indicator included in the paging information 602. In some embodiments, the requirements determination is based in part on configuration and operational information included in the PRD data 341. In particular, the PRD data 341 may, and in some embodiments does, include match criteria information and corresponding paging requirements information that enables the PRD module 340 to determine the specific paging requirements, e.g., IP datagrams may be matched to specific requirements using traditional packet classification techniques based on header fields.

Upon determination that the received paging information 602 warrants paging a dormant end node, the MA module 312 sends a page trigger signal 604 to the APA module 316, indicating that a particular dormant end node should be paged. Upon receiving and processing the page trigger signal 604, the APA module 316 sends a location request signal 606 to the TA module 314. The TA module 314 access its corresponding TA data 315 to determine the location information associated with the dormant end node and returns the information, e.g., location/paging area, access node, cell, sector and/or corresponding LPA, to the APA module 316 in a location response signal 608. The location information associated with the dormant end node may, and in some embodiments does, indicate a plurality of location/paging areas, access nodes, cells, sectors and/or LPAs, where the dormant end node may be located. When the location information comprises multiple such entities, a variety of paging strategies, e.g., blanket, expanding ring, or sequential, may be used to search for the dormant end node.

Upon receiving the location information associated with the dormant end node, e.g., via the location response signal 608, the APA module 316 determines the set of one or more access nodes or LPA modules to which page request signaling should be sent. In the FIG. 5 example, the APA module 316 (of the PRD module 340 located in the first access node 300) sends a page request signal 610 to the LPA module 318′ (of the PRC module 350′ located in the second access node 300′). The page request signal 610 contains an indication of the dormant end node to be paged and also includes an indication of the paging requirements determined by the PRD module 340 in the first access node 300.

The LPA module 318′ receives and processes the page request signal 610. The PRC module 350′ in the second access node 300′ interprets the determined requirements indicated in the page request signal 610 received from the PRD module 340 in the first access node 300 and uses the determined requirements to control paging operations and or subsequent page signaling. In some embodiments, the PRC module 350′ allocates one or more paging resources, e.g., a page transmission resource, based on the determined requirements corresponding to the received page request signal 610. Note that in some embodiments, the PRC module 350′ receives page request signals from one or more PRD modules, e.g., from one or more access nodes and/or paging nodes, and in some cases may have multiple page request pending simultaneously. In such embodiments, the PRC module 350′ allocates paging resources, e.g., transmits pages, as a function of the determined requirements corresponding to the pending requests. Thus, a pending page request with a time constraint requirement, e.g., indicating paging latency should be minimized or an upper bound on paging delay, may be serviced prior to other pending requests that were received earlier. Additionally, in some embodiments, a plurality of paging requests signals are associated as a group, e.g., a group with a common quality of service indicator, and one or more paging resources is allocated to the group, e.g., a minimum fraction of paging channel capacity or paging transmission opportunities is allocated for page requests associated with the group. In the FIG. 5 example, the LPA module 318′, as part of the PRC module 350′, sends a page request signal 612 for the particular dormant end node via the wireless communication interface 330′.

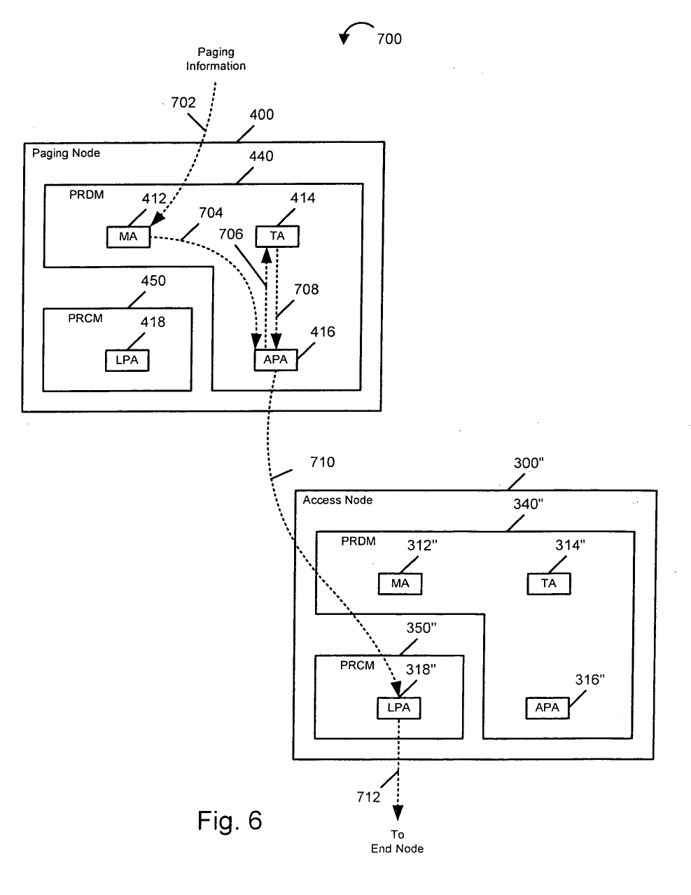

FIG. 6 provides a detailed illustration of exemplary signaling 700 in accordance with the present invention, when a paging operation is performed in a communication system with a more centralized paging system design. The paging operation is initiated by a paging node and location tracking information for the dormant end node to be paged indicates the dormant end node is within the scope of an LPA located in a given access node. In the FIG. 6 example, PRD functionality associated with the paging operation is performed by the paging node, while PRC functionality associated with the paging operation is performed by the access node. The FIG. 6 example depicts a paging node 400 and an access node 300″, each of which is implemented in accordance with the present invention. The FIG. 6 paging node 400 is a simplified representation of the exemplary paging node 400 depicted in FIG. 2, while the FIG. 6 access node 300″ is a simplified representation of an access node implemented in accordance with the exemplary access node 300 depicted in FIG. 2. In the context of the FIG. 1 exemplary communication system 100, the FIG. 6 paging node 400 may represent, e.g., a paging node 104 depicted in FIG. 1, while the FIG. 6 access node 300″ may represent, e.g., an access node 150 depicted in FIG. 1.

In the FIG. 6 illustration, the paging operation is initiated by the paging node 400 upon reception of paging information 702, e.g., a data message destined for a dormant end node or a control signal indicating that a dormant end node should be paged. The MA module 412 intercepts the paging information 702 and determines that a paging operation should be initiated. The PRD module 440 further analyses the received paging information 602 to determine the requirements of the paging operation to be initiated. In some embodiments of the present invention, the MA module 412, as part of the PRD module 440, further analyses the received paging information 702 to determine the requirements of the paging operation to be initiated. The requirements determination, made by the PRD module 440, is a function of at least one of a quality of service indicator, a type indicator, a source indicator and a destination indicator included in the paging information 702. In some embodiments, the requirements determination is based in part on configuration and operational information included in the PRD data 441. In particular, the PRD data 441 may, and in some embodiments does, include match criteria information and corresponding paging requirements information that enables the PRD module 440 to determine the specific paging requirements, e.g., IP datagrams may be matched to specific requirements using traditional packet classification techniques based on header fields.

Upon determination that the received paging information 702 warrants paging a dormant end node, the MA module 412 sends a page trigger signal 704 to the APA module 416, indicating that a particular dormant end node should be paged. Upon receiving and processing the page trigger signal 704, the APA module 416 sends a location request signal 706 to the TA module 414. The TA module 414 access its corresponding TA data 415 to determine the location information associated with the dormant end node and returns the information, e.g., location/paging area, access node, cell, sector and/or corresponding LPA, to the APA module 416 in a location response signal 708. The location information associated with the dormant end node may, and in some embodiments does, indicate a plurality of location/paging areas, access nodes, cells, sectors and/or LPAs, where the dormant end node may be located. When the location information comprises multiple such entities, a variety of paging strategies, eg., blanket, expanding ring, or sequential, may be used to search for the dormant end node.

Upon receiving the location information associated with the dormant end node, e.g., via the location response signal 708, the APA module 416 determines the set of one or more access nodes or LPA modules to which page request signaling should be sent. In the FIG. 6 example, the APA module 416 (of the PRD module 440 located in the paging node 400) sends a page request signal 710 to the LPA module 318″ (of the PRC module 350″ located in the access node 300″). The page request signal 710 contains an indication of the dormant end node to be paged and also includes an indication of the paging requirements determined by the PRD module 440 in the paging node 400.

The LPA module 318″ receives and processes the page request signal 710. The PRC module 350″ in the access node 300″ interprets the determined requirements indicated in the page request signal 710 received from the PRD module 440 in the paging node 400 and uses the determined requirements to control paging operations and or subsequent page signaling. In some embodiments, the PRC module 350″ allocates one or more paging resources, e.g., a page transmission resource, based on the determined requirements corresponding to the received page request signal 710. Note that in some embodiments, the PRC module 350″ receives page request signals from one or more PRD modules, e.g., from one or more access nodes and/or paging nodes, and in some cases may have multiple page request pending simultaneously. In such embodiments, the PRC module 350″ allocates paging resources, e.g., transmits pages, as a function of the determined requirements corresponding to the pending requests. Thus, a pending page request with a time constraint requirement, e.g., indicating paging latency should be minimized or an upper bound on paging delay, may be serviced prior to other pending requests that were received earlier. Additionally, in some embodiments, a plurality of paging requests signals are associated as a group, e.g., a group with a common quality of service indicator, and one or more paging resources is allocated to the group, e.g., a minimum fraction of paging channel capacity or paging transmission opportunities is allocated for page requests associated with the group. In the FIG. 6 example, the LPA module 318″, as part of the PRC module 350″, sends a page request signal 712 for the particular dormant end node via the wireless communication interface 330″.

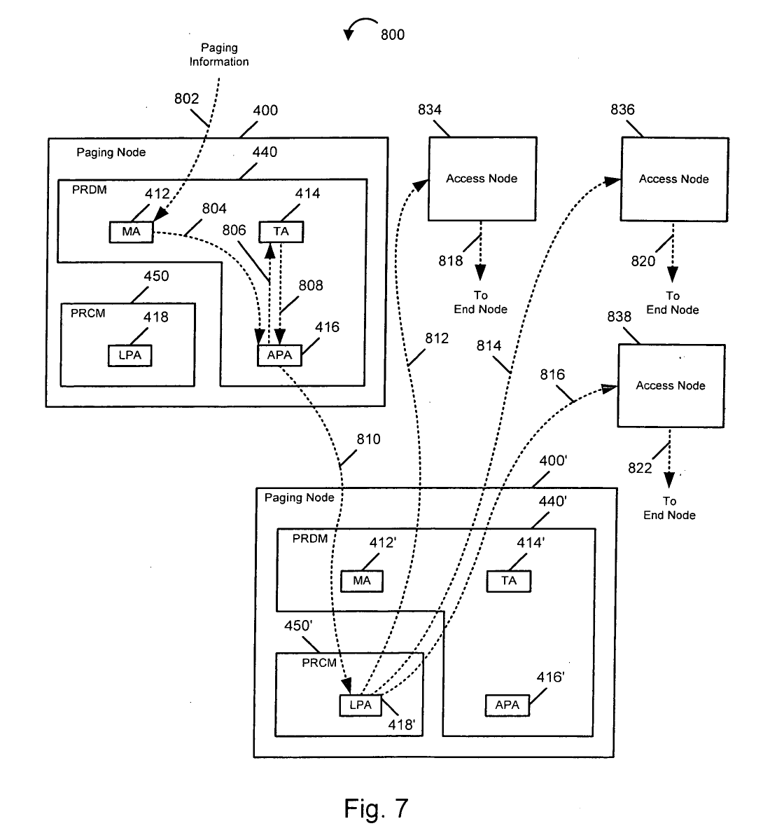

FIG. 7 provides a detailed illustration of exemplary signaling 800 in accordance with the present invention, when a paging operation is performed in a communication system with a more centralized paging system design and the paging operation includes paging between portions of the communication system with dissimilar technologies. The paging operation is initiated by a first paging node and location tracking information for the dormant end node to be paged indicates the dormant end node is within the scope of an LPA located in a second paging node, where the scope of the second paging node includes access nodes with a technology different than that of the first paging node. In the FIG. 7 example, PRD functionality associated with the paging operation is performed by the first paging node, while PRC functionality associated with the paging operation is performed by the second paging node. The FIG. 7 example depicts two paging nodes 400, 400′, implemented in accordance with the present invention, and a plurality of access nodes 834, 836, 838. Each of the FIG. 7 paging nodes 400, 400′ is a simplified representation of a paging node implemented in accordance with the exemplary paging node 400 depicted in FIG. 2. In the context of the FIG. 1 exemplary communication system 100, the first FIG. 7 paging node 400 may represent, e.g., a first paging node 104 depicted in FIG. 1, the second FIG. 7 paging node 400′ may represent, e.g., a second paging node 130 depicted in FIG. 1, and the three FIG. 7 access nodes 834, 836, 838 may represent, e.g., the three access nodes 134, 136, 138 included in the same dissimilar network 160 as the second paging node 130 depicted in FIG. 1.

In the FIG. 7 illustration, the paging operation is initiated by the first paging node 400 upon reception of paging information 802, e.g., a data message destined for a dormant end node or a control signal indicating that a dormant end node should be paged. The MA module 412 intercepts the paging information 802 and determines that a paging operation should be initiated. The PRD module 440 further analyses the received paging information 802 to determine the requirements of the paging operation to be initiated. In some embodiments of the present invention, the MA module 412, as part of the PRD module 440, further analyses the received paging information 802 to determine the requirements of the paging operation to be initiated. The requirements determination, made by the PRD module 440, is a function of at least one of a quality of service indicator, a type indicator, a source indicator and a destination indicator included in the paging information 802. In some embodiments, the requirements determination is based in part on configuration and operational information included in the PRD data 441. In particular, the PRD data 441 may, and in some embodiments does, include match criteria information and corresponding paging requirements information that enables the PRD module 440 to determine the specific paging requirements, e.g., IP datagrams may be matched to specific requirements using traditional packet classification techniques based on header fields.

Upon determination that the received paging information 802 warrants paging a dormant end node, the MA module 412 sends a page trigger signal 804 to the APA module 416, indicating that a particular dormant end node should be paged. Upon receiving and processing the page trigger signal 804, the APA module 416 sends a location request signal 806 to the TA module 414. The TA module 414 access its corresponding TA data 415 to determine the location information associated with the dormant end node and returns the information, e.g., location/paging area, access node, cell, sector and/or corresponding LPA, to the APA module 416 in a location response signal 808. The location information associated with the dormant end node may, and in some embodiments does, indicate a plurality of location/paging areas, access nodes, cells, sectors and/or LPAs, where the dormant end node may be located. When the location information comprises multiple such entities, a variety of paging strategies, e.g., blanket, expanding ring, or sequential, may be used to search for the dormant end node.

Upon receiving the location information associated with the dormant end node, e.g., via the location response signal 808, the APA module 416 determines the set of one or more access nodes or LPA modules to which page request signaling should be sent. In the FIG. 7 example, the APA module 416 (of the PRD module 440 located in the first paging node 400) sends a page request signal 810 to the LPA module 418′ (of the PRC module 450′ located in the second paging node 400′). The page request signal 810 contains an indication of the dormant end node to be paged and also includes an indication of the paging requirements determined by the PRD module 440 in the first paging node 400.

The LPA module 418′ receives and processes the page request signal 810. The PRC module 450′ in the second paging node 400′ interprets the determined requirements indicated in the page request signal 810 received from the PRD module 440 in the first paging node 400 and uses the determined requirements to control paging operations and or subsequent page signaling. In some embodiments, the PRC module 450′ allocates one or more paging resources, e.g., a page transmission resource, based on the determined requirements corresponding to the received page request signal 810. Note that in some embodiments, the PRC module 450′ receives page request signals from one or more PRD modules, e.g., from one or more access nodes and/or paging nodes, and in some cases may have multiple page request pending simultaneously. In such embodiments, the PRC module 450′ allocates paging resources, e.g., transmits pages, as a function of the determined requirements corresponding to the pending requests. Thus, a pending page request with a time constraint requirement, e.g., indicating paging latency should be minimized or an upper bound on paging delay, may be serviced prior to other pending requests that were received earlier. Additionally, in some embodiments, a plurality of paging requests signals are associated as a group, e.g., a group with a common quality of service indicator, and one or more paging resources is allocated to the group, e.g., a minimum fraction of paging channel capacity or paging transmission opportunities is allocated for page requests associated with the group.

In the FIG. 7 example, the LPA module 418′, as part of the PRC module 450′, sends a page request signals 812, 814, 816 for the particular dormant end node to a plurality of access nodes 834, 836, 838. Each of the access nodes 834, 836, 838 sends a corresponding page signal 818, 820, 822 in its respective cell via its wireless interface. Note that in this example the paging operations and signaling performed by the access nodes 834, 836, 838 are essentially controlled by the PRC module 450′located in the second paging node 400′.

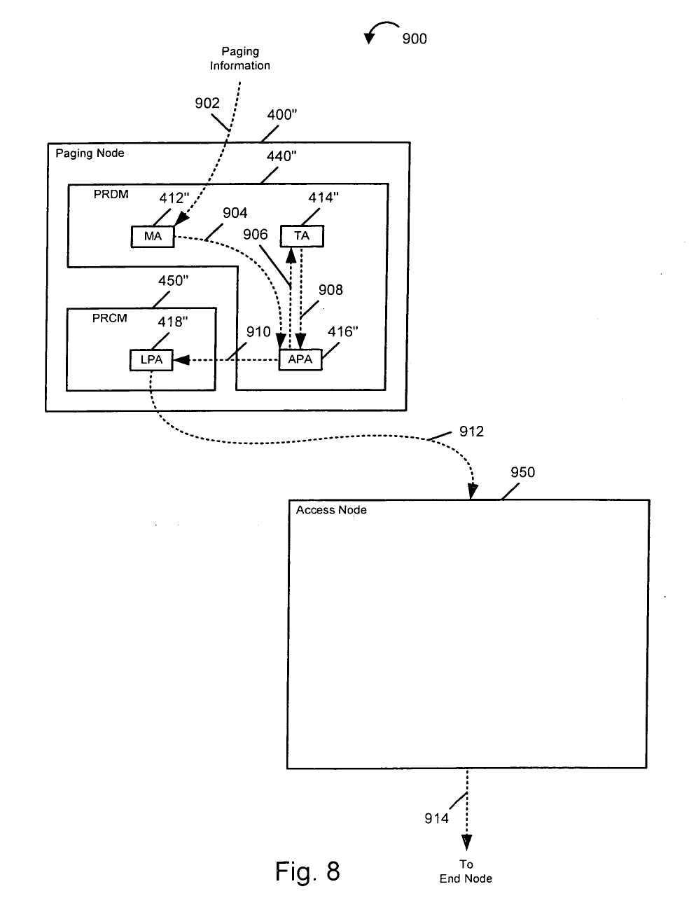

FIG. 8 provides a detailed illustration of exemplary signaling 900 in accordance with the present invention, when a paging operation is performed in a communication system with an centralized paging system design and when the tracking information for the dormant end node to be paged indicates the dormant end node is within the scope of an LPA co-located in the same paging node that initiates the paging operation. In the FIG. 8 example, both PRD functionality and PRC functionality associated with the paging operation are performed by the same paging node. In the FIG. 8 example, a single paging node 400″, implemented in accordance with the present invention, is depicted with single access node 950. The FIG. 8 paging node 400″ is a simplified representation of a paging node implemented in accordance with the exemplary paging node 400 depicted in FIG. 3. In the context of the FIG. 1 exemplary communication system 100, the FIG. 8 paging node 400″ may represent, e.g., a paging node 104 depicted in FIG. 1.

In the FIG. 8 illustration, the paging operation is initiated by the paging node 400″ upon reception of paging information 902, e.g., a data message destined for a dormant end node or a control signal indicating that a dormant end node should be paged. The MA module 412″ intercepts the paging information 902 and determines that a paging operation should be initiated. The PRD module 440″ further analyses the received paging information 902 to determine the requirements of the paging operation to be initiated. In some embodiments of the present invention, the MA module 412″, as part of the PRD module 440″, further analyses the received paging information 902 to determine the requirements of the paging operation to be initiated. The requirements determination, made by the PRD module 440″, is a function of at least one of a quality of service indicator, a type indicator, a source indicator and a destination indicator included in the paging information 902. In some embodiments, the requirements determination is based in part on configuration and operational information included in the PkD data 441″. In particular, the PRD data 441″ may, and in some embodiments does, include match criteria information and corresponding paging requirements information that enables the PRD module 440″ to determine the specific paging requirements, e.g., IP datagrams may be matched to specific requirements using traditional packet classification techniques based on header fields.

Upon determination that the received paging information 902 warrants paging a dormant end node, the MA module 412″ sends a page trigger signal 904 to the APA module 416″, indicating that a particular dormant end node should be paged. Upon receiving and processing the page trigger signal 904, the APA module 416″ sends a location request signal 906 to the TA module 414″. The TA module 414″ access its corresponding TA data 415″ to determine the location information associated with the dormant end node and returns the information, e.g., location/paging area, access node, cell, sector and/or corresponding LPA, to the APA module 416″ in a location response signal 908. The location information associated with the dormant end node may, and in some embodiments does, indicate a plurality of location/paging areas, access nodes, cells, sectors and/or LPAs, where the dormant end node may be located. When the location information comprises multiple such entities, a variety of paging strategies, e.g., blanket, expanding ring, or sequential, may be used to search for the dormant end node.

Upon receiving the location information associated with the dormant end node, e.g., via the location response signal 908, the APA module 416″ determines the set of one or more access nodes or LPA modules to which page request signaling should be sent. In the FIG. 8 example, the APA module 416″ (of the PRD module 440″) sends a page request signal 910 to the LPA module 418″ (of the PRC module 450″ located in same paging node 400″). The page request signal 910 contains an indication of the dormant end node to be paged, and in some embodiments, the page request signal also includes an indication of the paging requirements determined by the PRD module 440″. Note that in the FIG. 8 example, since the PRD module 440″ and PRC module 450″ are co-located in the same paging node 400″, the determined paging requirements may be, and in some embodiments is, conveyed via other means, e.g., through shared memory.

The LPA module 418″ receives and processes the page request signal 910. The PRC module 450″ interprets the determined requirements conveyed from the PRD module 440″ and uses the determined requirements to control paging operations and or subsequent page signaling. In some embodiments, the PRC module 450″ allocates one or more paging resources, e.g., a page transmission resource, based on the determined requirements corresponding to the received page request signal 910. Note that in some embodiments, the PRC module 450″ receives page request signals from one or more PRD modules, e.g., from one or more access nodes and/or paging nodes, and in some cases may have multiple page request pending simultaneously. In such embodiments, the PRC module 450″ allocates paging resources, e.g., transmits pages, as a function of the determined requirements corresponding to the pending requests. Thus, a pending page request with a time constraint requirement, e.g., indicating paging latency should be minimized or an upper bound on paging delay, may be serviced prior to other pending requests that were received earlier. Additionally, in some embodiments, a plurality of paging requests signals are associated as a group, e.g., a group with a common quality of service indicator, and one or more paging resources is allocated to the group, e.g., a minimum fraction of paging channel capacity or paging transmission opportunities is allocated for page requests associated with the group.

In the FIG. 8 example, the LPA module 418″, as part of the PRC module 450″, sends a page request signal 912 for the particular dormant end node to an access node 950. The access node 950 sends a corresponding page signal 914 in its respective cell via its wireless interface. Note that in this example the paging operations and signaling performed by the access node 950 are essentially controlled by the PRC module 450″ located in the paging node 400″.

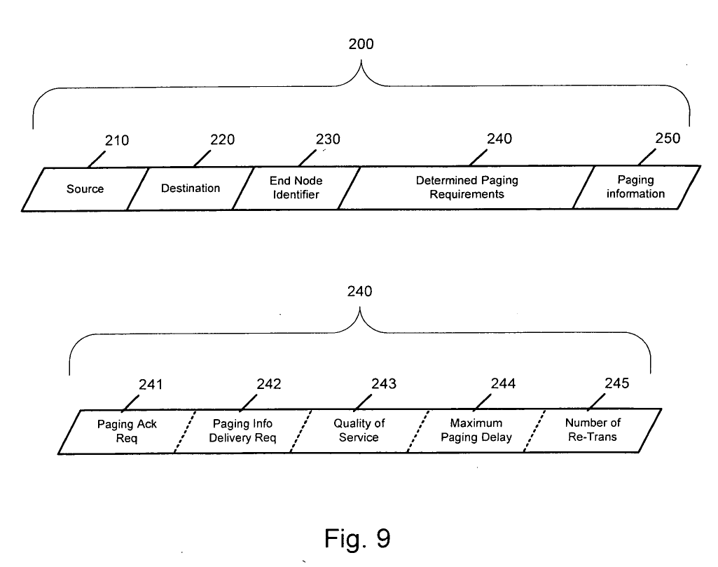

FIG. 9 depicts an exemplary paging request message 200, as may be used to convey determined requirements from a PRD functional entity to a PRC functional entity. The FIG. 9 message is an exemplary embodiment of a paging request signal 510, 610, 710, 810, 910 as illustrated in FIGS. 4-8. The FIG. 9 embodiment depicts a plurality of fields used to convey information. In particular, the FIG. 9 exemplary paging request message includes a source field 210, a destination field 220, an end node identifier field 230, a determined paging requirements field 240 and a paging information field 250. The source field 210 and destination field 220 are used to, e.g., route the paging request message to the intended PRC functional entity and/or enable the receiving PRC functional entity to return a corresponding response message back to the sending PRD functional entity. The end node identifier field 230 is used to, e.g., indicate the dormant end node that is to be paged. The determined paging requirements field 240 is used to, e.g., indicate the paging requirements as determined by the sending PRD functional entity. The paging information field 250 is used to, e.g., deliver a portion of the paging information received by the PRD functional entity, reception of which resulted in initiation of the paging operation.

The FIG. 9 illustration also depicts specific sub-fields included in the determined paging requirements field 240, in accordance with some embodiments of the present invention. In particular, the FIG. 9 exemplary determined paging requirements field 240 includes a paging acknowledgment required sub-field 241, e.g., flag, a paging information delivery required sub-field 242, e.g., flag, a quality of service required sub-field 243, a maximum paging delay sub-field 244 and a number of retransmissions sub-field 245. The paging acknowledgment required sub-field 241 indicates, e.g., whether an acknowledgement of the page is required. Note that when an acknowledgement is not required the receiving end node may remain in a power conserving state after receiving the page. The paging information delivery required sub-field 242 indicates, e.g., the PRC functional entity should deliver the contents of the paging information field 250 to the end node, e.g., in a transmitted page signal. The quality of service sub-field 243 indicates, e.g., the required quality of service for the corresponding page. The maximum paging delay sub-field 244 indicates, e.g., an upper bound on delay that is acceptable for the corresponding page. The number of retransmissions sub-field 245 indicates, e.g., the number of times that a page should be retransmitted. In some embodiments this field indicates a number of proactive retransmissions, while in other embodiments it indicates a maximum number of re-transmissions in the absence of an acknowledgment.

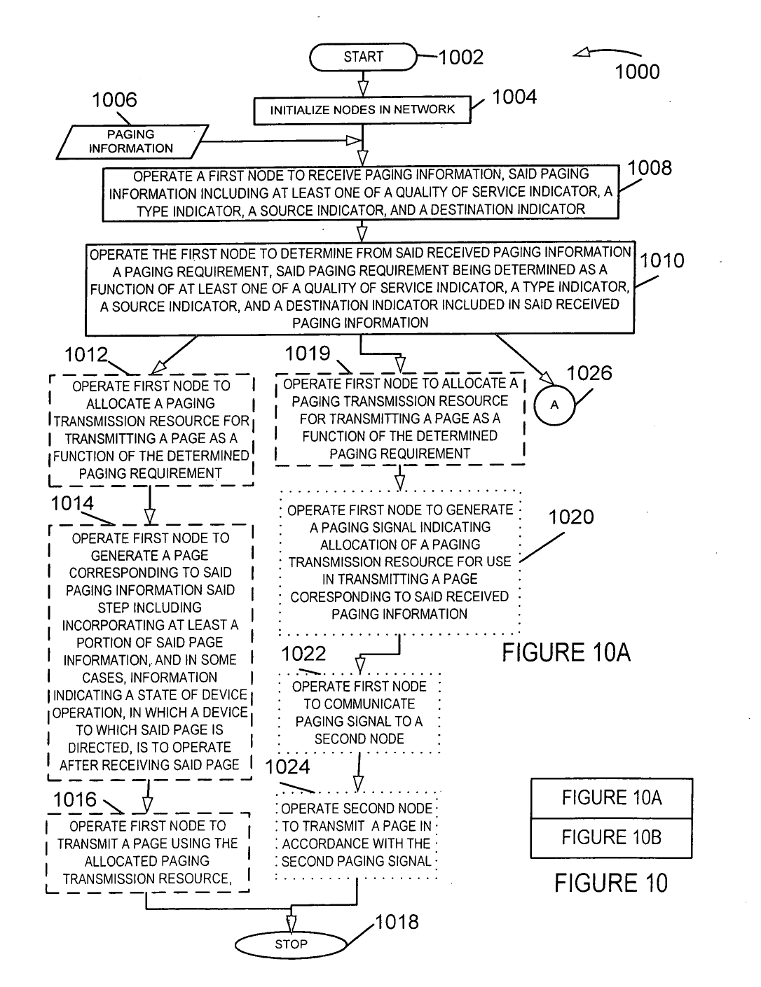

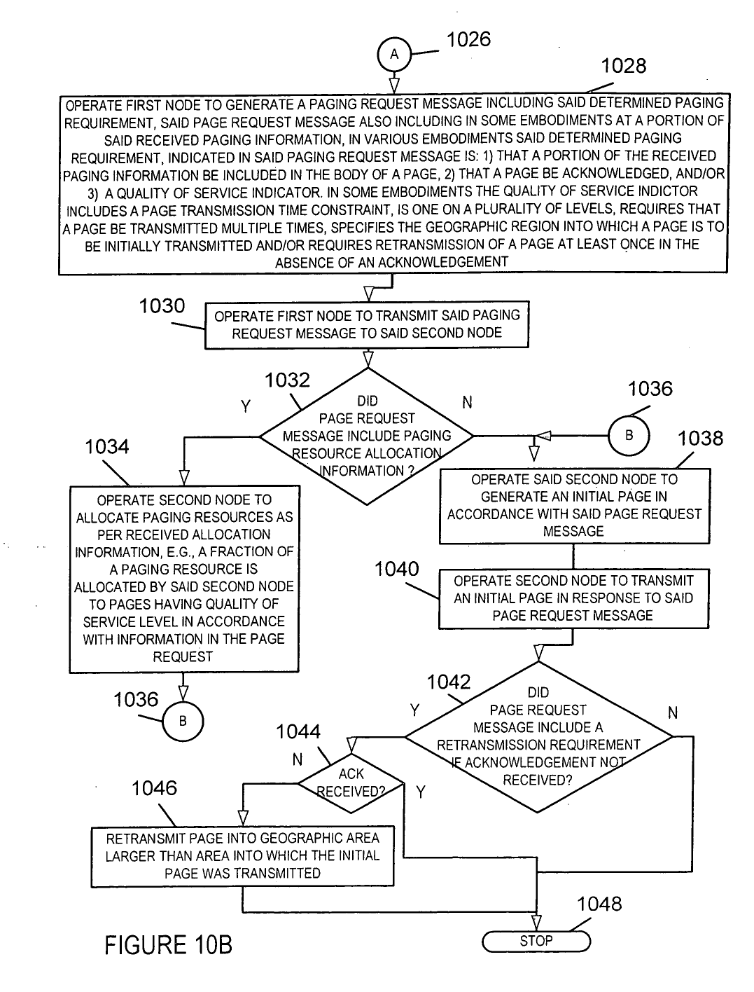

FIG. 10 illustrates a flow chart 1000 showing the steps of various paging methods implemented in accordance with the present invention. The paging methods of the invention start at node 1002 with initialization of network nodes occurring in step 1004. Once initialization is complete, paging is possible, e.g., one or more mobile nodes may be paged. In step 1008 a first node receives paging information 1006. Paging information 1006 may be, e.g., an IP packet the payload of which is intended to be transmitted as a page or a control signal intended to initiate a paging operation. In the flow chart, the first node is the node which receives the paging information. Depending on the physical implementation this may be a node in the core of the network or an access node used to couple end nodes to the network. In step 1008 the first node is operated to receive paging information which includes a quality of service indicator, a type indicator, a source indicator and/or a destination indicator which can be used to determine a paging requirement. In step 1010 the first node is operated to determine a paging requirement from at least one of a quality of service indicator, a type indicator, a source indicator and a destination indicator included in the received paging information. Operation proceeds from step 1010 to one of steps 1012, 1019 and 1028 (via flow chart connector 1026) depending on the physical implementation. The first path beginning with step 1012 corresponds to the case where the first node is, e.g., an access node which will determine paging requirements and then actually transmit a page corresponding to the received paging information 1026. The second path which begins with step 1019 corresponds to the case were the first node is, e.g., a core node which determines the paging requirements and allocates paging resources. In the second processing path the first node then relies on another node, e.g., an access node, to transmit the page using the allocated resources. The allocated resources maybe, e.g., bandwidth, frequency, transmission time slots, transmission power, etc. The third processing path corresponds to the case where the first node is, e.g., a core or access node that generates a paging request message and transmits the message including determined paging requirements to another node, e.g., the node responsible for allocating paging transmission resources and transmitting the page corresponding to the received paging information 1006.

In step 1012, which marks the start of the first processing path corresponding to an embodiment where the first node is, e.g., an access node, the first node is operated to allocate a paging transmission resource for transmitting a page as a function of the determined paging requirement. If the paging requirement involved a transmission delay, e.g., maximum latency, the access node takes this into consideration when scheduling the first page. Assuming that the paging requirement is a transmission power level or frequency which is to be used to transmit the page, the access node allocates the required power and/or frequency for transmitting the page corresponding to the paging information 1006. Next, in step 1014, the first node generates a page corresponding to the paging information. This step includes, in some embodiments, incorporating at least a portion of the paging information 1006 into the page and, in some cases, information indicating a state of device operation in which a device to which the page is directed is to operate after receiving the page. The information on device state of operation may indicate that a mobile should operate in one of a plurality of states, e.g., a hold state, instead of a full on or sleep state. In some cases a hold state is a low power state in which the mobile is able to receive data but not transmit data.

Operation proceeds from step 1014 to step 1016 wherein the generated page is transmitted. Assuming no repeat transmissions or acknowledgement signaling, operation regarding processing of the received paging information 1006 is complete and processing relating to the particular set of paging information 1006 stops in step 1018.

The second processing path corresponds to the case where the first node, e.g., a core node, is responsible for allocating paging resources in accordance with the determined requirements but another node, e.g., a second node which may be an access node is responsible for transmitting the page. In step 1019 the first node is operated to allocate a paging transmission resource for transmitting a page as a function of the determined paging requirement. Then in step 1020, the first node is operated to generate a paging signal indicating allocation of a paging transmission resource for use in transmitting a page corresponding to said received paging information 1006. The allocation of a paging resource is performed in accordance with the page requirements determined in step 1010. The generated paging signal is communicated in step 1022 to a second node, e.g., access node which in step 1024 transmits a page corresponding toe the paging information 1006 using the allocated paging resource(s) specified in the paging signal. Assuming no repeat transmissions or acknowledgement signaling, operation regarding processing of the received paging information 1006 and the transmission of a page is complete and processing relating to the particular set of paging information 1006 stops in step 1018.

The third processing path begins with step 1028. Processing proceeds from step 1010 to step 1028 via flow chart connecting element 1026. This processing path corresponds to a case where a novel paging request message which conveys paging requirement information in accordance with the invention is used. In step 1028, the first node generates a paging request message in accordance with the invention taking into consideration the determined paging requirements. In some embodiments the paging request message includes one or more determined paging requirements in addition to a message source and destination identifier. The paging message may include a page destination identifier identifying a mobile node to which a page is to be sent. In some embodiments the paging request message includes a portion of the paging information 1006, e.g., information which is intended to by used as the payload of a page. As discussed previously the paging requirement information included in the message may be one or more of a wide range of page requirements. In various embodiments the determined paging requirement information in the paging request message indicates 1) that a portion of the received paging information be included in the body of a page; 2) that a page be acknowledged; and/or 3) a quality of service. The quality of service requirement may indicate, e.g., a paging transmission time constraint, one of a plurality of different quality of service levels, that a page is to be transmitted multiple times, the geographic region (e.g., cell or group of cells) into which the page is to be initially transmitted and/or that retransmission of a page is to occur at least once in the absence of receiving an acknowledgement indicating that the page was received. From step 1028 operation proceeds to step 1030 where the generated paging request message is transmitted to a second node, e.g., an access node which transmits pages.

In step 1032, the second node which receives the paging request message determines if the paging request message included paging resource allocation information, e.g., information used to control allocation of paging resources to one or a group of pages. If resource allocation information is included in the paging request message operation proceeds from step 1032 to step 1034.

In step 1034, the second node allocates paging resources in accordance with the resource allocation information (e.g., instruction) included in the received paging request message. For example, a fraction of a particular paging resource, e.g., number of page transmission time slots, may be allocated by the second node to pages having a particular quality of service level as per allocation information included in the paging request message. Once paging resources are allocated in accordance with the content of the received paging request message, operation proceeds from step 1034 to step 1038 via connecting element 1036. Operation proceeds directly to step 1038 from step 1032 in those cases where the paging request message does not include paging resource allocation information.

In step 1038 the second node is operated to generate an initial page in accordance with the paging request message. Then, in step 1040 the page is transmitted. Next, in step 1042 a determination is made as to whether or not the paging request message included a retransmission requirement, e.g., in the event an acknowledgement of the page is not received. If no retransmission requirement exists, processing regarding the received paging information 1006 stops in step 1048. However, if a retransmission requirement exists, operation proceeds from step 1042 to step 1044. In step 1044 a determination is made as to whether or not an acknowledgement was received. If no acknowledgment was received the page is retransmitted, in step 1046. Retransmission may be into a geographic area larger than the area into which the initial page was transmitted. This retransmission area, like the initial paging area, may be, and sometimes is, specified in the paging request message as one of the various paging requirements included in the message.

Operation proceeds from retransmission step 1046 or from acknowledgement step 1044 in the case of a received acknowledgement, to step 1048 where processing regarding receive paging information 1006 stops. While processing of a particular set of paging information 1006 stops in step 1048 it is to be understood that the first node will continue to receive and process additional set of paging information 1006 over time.

In some embodiments of the present invention, communications between nodes is based all, or in part, on the Internet Protocol (IP). Thus, communication of both data and/or control signaling between the network nodes may use IP packets, e.g., datagrams. In embodiments of the present invention that utilize IP packets, said IP packets may be delivered to the intended destination nodes using either unicast or multicast addressing and delivery mechanisms. The use of IP multicast is particular useful when the same information is sent from one node to a plurality of other nodes. In some embodiments of the present invention, IP multicast is used for delivery of page request signals sent from an APA or PRD functional entity that target a plurality of nodes, e.g., a set of access nodes, LPAs or PRC functional entities. In cases where the same information, e.g., packet payload data, is sent to a plurality of targeted nodes using unicast delivery, a separate IP packet with a copy of the information is sent by the source node to each targeted node. Alternatively, when the same information is sent to a plurality of targeted nodes using multicast delivery, a single IP packet with the information is sent by the source node and network nodes replicate the packet as required for delivery to each targeted node. Thus, IP multicast provides a more efficient method of delivering information from a source node to a group of destination nodes.

Various features of the present invention are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods. Accordingly, among other things, the present invention is directed to a machine-readable medium including machine executable instructions for causing a machine, e.g., processor and associated hardware, to perform one or more of the steps of the above-described method(s).

Numerous additional variations on the methods and apparatus of the present invention described above will be apparent to those skilled in the art in view of the above description of the invention. Such variations are to be considered within the scope of the invention. The methods and apparatus of the present invention may be, and in various embodiments are, used with code division multiple access (CDMA), orthogonal frequency division multiplexing (OFDM), or various other types of communications techniques which may be used to provide wireless communications links between access nodes and mobile nodes. In some embodiments the access nodes are implemented as base stations which establish communications links with mobile nodes using OFDM and/or CDMA. In various embodiments the mobile nodes are implemented as notebook computers, personal data assistants (PDAs), or other portable devices including receiver/transmitter circuits and logic and/or routines, for implementing the methods of the present invention.

What is claimed is:

1. A method of processing paging information in a communications system, the method comprising:
operating a first node to receive said paging information, said paging information including at least one of a quality of service indicator, a type indicator, a source indicator, and a destination indicator; and
operating the first node to determine from said received paging information a paging requirement, said paging requirement being determined as a function of said at least one of a quality of service indicator, a type indicator, a source indicator, and a destination indicator.

2. The method of claim 1, further comprising:
operating said first node to allocate a paging transmission resource for transmitting a page as a function of the determined paging requirement.

3. The method of claim 2, further comprising:
operating said first node to transmit a page using the allocated paging transmission resource.

4. The method of claim 3, wherein said step of transmitting a page includes incorporating into said page information indicating a state of device operation, in which a device to which said page is directed, is to operate after receiving said page.

5. The method of claim 2, further comprising:
operating said first node to communicate a paging signal to a second node, indicating allocation of a paging transmission resource for use in transmitting a page corresponding to said received paging information.

6. The method of claim 1, further comprising:
operating said first node to communicate said determined paging requirement to a second node in a paging request message.

7. The method of claim 6, wherein said page request message includes at least a portion of said received paging information.

8. The method of claim 7, wherein said determined paging requirement, indicated in said paging request message, is that said portion be included in a page.

9. The method of claim 6, wherein said determined paging requirement, indicated in said paging request message, is that a page be acknowledged.

10. The method of claim 6, wherein said determined paging requirement, indicated in said paging request message, is a quality of service.

11. The method of claim 10, wherein said quality of service includes a page transmission timing constraint.

12. The method of claim 10, wherein said quality of service is one of a plurality of levels.

13. The method of claim 10, wherein said quality of service requires that a page be transmitted multiple times.

14. The method of claim 10, wherein said quality of service requires retransmission of a page at least once in the absence of an acknowledgment.

15. The method of claim 14, further comprising:
operating the second node to cause said re-transmission of said page to be into a geographic area larger than an initial transmission area of said page.

16. The method of claim 6,
wherein said determined paging requirement, indicated in said paging request message, is a quality of service level; and
wherein said page request message includes paging resource allocation information indicating a fraction of a paging resource to be allocated by said second node to pages having said quality of service level, the method further comprising:
operating the second node to allocate said fraction of said paging resource to pages having a quality of service level indicated in said paging request message.

17. The method of claim 6, further comprising:
operating said second node to allocate a paging transmission resource for transmitting a page, as a function of said determined paging requirement, indicated in said paging request message.

18. The method of claim 17, further comprising:
operating said second node to transmit a page using the allocated paging transmission resource.

19. The method of claim 17, further comprising:
operating said second node to communicate a paging signal to a third node, indicating allocation of a paging transmission resource for use in transmitting a page corresponding to said paging information.

20. A machine readable medium including a data structure in the form of a paging request message stored thereon, said paging request message including:
a source node identifier;
a destination node identifier; and
paging message requirement information.

21. The machine readable medium of claim 20, wherein said paging request message further includes:
a paging message payload including information to be transmitted in a page.

22. The machine readable medium of claim 20, wherein said paging message requirement information includes:
information indicating whether or not an acknowledgement to a page is required.

23. The machine readable medium of claim 22, wherein said paging message requirement information includes:
information indicating a number of retransmissions to be made if a page acknowledgement is not received.

24. The machine readable medium of claim 22, wherein said paging message requirement information includes:
page transmission quality of service information.

25. The machine readable medium of claim 22, wherein said paging message requirement information includes:
page transmission timing constraint information.

26. The machine readable medium of claim 22, wherein said paging message requirement information is stored in an encoded format and includes at least page transmission quality of service information and page transmission timing constraint information.

27. A communications system comprising:
a first node including:
i) means for receiving paging information, said paging information including at least one of a quality of service indicator, a type indicator, a source indicator, and a destination indicator; and
ii) means for determining from said received paging information a paging requirement, said paging requirement being determined as a function of said at least one of a quality of service indicator, a type indicator, a source indicator, and a destination indicator.

28. The system of claim 27, wherein said first node, further comprises:
means for allocating a paging transmission resource for transmitting a page as a function of a determined paging requirement.

29. The system of claim 28, wherein said first node further includes a radio transmitter for transmit a page using the allocated paging transmission resource.

30. The system of claim 29, wherein said first node further includes:
means for generating a paging request message including information indicating said determined paging requirement; and
means for transmitting said paging request message to another node.

31. The system of claim 30, wherein said page request message includes at least a portion of said received paging information and wherein said determined paging requirement, indicated in said paging request message, is that said portion be included in a page.

32. The system of claim 30, wherein said determined paging requirement, indicated in said paging request message, is that a page be acknowledged.

33. The system of claim 30, wherein said determined paging requirement, indicated in said paging request message, is a quality of service requirement.

34. The system of claim 30, further comprising:
a second node, said second node including:
i) means for receiving said paging request message;
ii) means for allocating at least one paging resource as a function of paging requirement information included in a received paging request message; and
iii) means for transmitting a page to a mobile node using the at least one allocated paging resource.
